(19) United States
(12) Patent Application Publication
(10) Pub. No.: US 2009/0136403 A1
(43) Pub. Date: May 28, 2009

(54) DECOMPOSITION OF DINITROGEN MONOXIDE IN OXYGEN-CONTAINING GASES HAVING A MOISTURE CONTENT

(75) Inventors: STEFAN KOCH, GELNHAUSEN (DE); RAINER KIEMEL, LANGENSELBOLD (DE); GABRIELLE PRZIBILLA, HANAU (DE)

Correspondence Address: NORRIS, MCLAUGHLIN & MARCUS, PA, 875 THIRD AVENUE, 18TH FLOOR, NEW YORK, NY, 10022, US

(73) Assignee: W.C. HERAEUS GMBH, HANAU (DE)

(21) Appl. No.: 12/275,711

(22) Filed: Nov. 21, 2008

(30) Foreign Application Priority Data
Nov. 26, 2007 (DE) 10 2007 057 109.9

(51) Int. Cl. B01D 53/56

(52) U.S. Cl. 423/239.1

(57) ABSTRACT

Palladium on aluminium oxide carrier is very well-suited for decomposing dinitrogen monoxide-contained, e.g., in anaesthetic gases—in oxygen-containing gases having a moisture content of 5-20% H₂O (or 5-10% H₂O) at temperatures <450° C. The palladium content of the catalyst preferably is <2 wt.-% with respect to Al₂O₃.

The invention relates to the decomposition of dinitrogen monoxide, contained, e.g., in anaesthetic gases, in oxygen-containing gases having a moisture content.

Various anaesthetic gases with a detrimental effect on the environment are employed in anaesthesiology. In particular nitrous oxide (as carrier gas) and isoflurane have an ozone-destroying effect and contribute to the greenhouse gas effect. Nitrous oxide is approximately 300-fold more damaging for the climate than carbon dioxide. For this reason, apparatuses for the destruction of nitrous oxide are needed not only in chemical processes, but also for cleaning of the exhaust air of hospitals.

According to JP 2002253967 A1, Ru or Pd on SiO₂ or Al₂O₃ serve for the destruction of excess nitrous oxide in anaesthetic gases. The corresponding reactors are steel pipes that are filled with a packing of precious metal-coated Al₂O₃ grains and operated at 150 to 550° C. (JP 55031463 A1). The decomposition of nitrous oxide in gas mixtures containing moisture or exhaled air is not described therein.

WO0268117A1 describes catalysts for the decomposition of excess anaesthetic gases. The decomposition of nitrous oxide in gas mixtures containing breathed air or moisture is not described therein. The Al₂O₃ carrier materials known from JP2002253967A1 are considered to be less well-suited than the claimed SiO₂ or SiO₂/Al₂O₃ carriers.

DE 35 43 640 A1 recommends Pd catalysts with alpha-aluminium oxide carrier for the decomposition of nitrous oxide that is pure or present in gas mixtures for the production of air for breathing in astronautics. Example 4 describes the use of catalysts of this type for N₂O destruction in air containing 14% N₂O and 4% H₂O (gaseous) at temperatures ranging from 495° C. to 560° C.

Altogether, the suitability of a catalyst depends very strongly on the type of N₂O-containing gas mixture that is treated. Many known catalysts exert a satisfactory effect only at very high temperatures which leads to a major technological effort since the gas stream containing the N₂O must first be heated. In some cases, it is necessary to dry the gas stream through additional technological efforts in order to attain satisfactory conversion being the complete destruction of the nitrous oxide. Accordingly, there is always a need in this industry for methods that destroy N₂O effectively, mainly in moisture-containing gas mixtures, at temperatures that are as low as possible.

It is therefore the object of the present invention to provide a low-temperature method for nitrous oxide decomposition in real, moisture-containing gases such as, e.g., in mixtures of exhaled air and anaesthetic gases.

It was surprising to find that Pd on aluminium oxide is very well-suited for decomposing nitrous oxide in air with a high moisture content, in particular in gas mixtures containing exhaled air, at relatively low temperatures (up to 450° C.).

The object has been met by a use according to claim 1.

Accordingly, the invention relates to the use of palladium on aluminium oxide carrier for decomposing dinitrogen monoxide-contained, e.g., in anaesthetic gases—in oxygen-containing gas mixtures having a moisture content at temperatures below 450° C., in particular at 400-420° C. in this context, the palladium content of the catalyst preferably is up to 2 wt.-% with respect to Al₂O₃.

The use according to the invention effectively provides a low-temperature method for nitrous oxide decomposition in real, moisture-containing gases such as, e.g., mixtures of exhaled air and anaesthetic gases.

Preferably, the oxygen-containing gas mixture is air. The moisture content can be 5-20% and usually is 5-10% H₂O. The palladium content of the catalyst generally is up to 2 wt.-% with respect to Al₂O₃.

The following exemplary embodiment illustrates the invention in more detail. Like in the other parts of the description, specification of parts and percentages refers to the weight unless specified otherwise.

Example: Decomposition of Nitrous Oxide in a Moisture-Containing Mode Gas Mixture

Experimental conditions:

Space velocity¹: >=4000 h⁻¹

Gas composition: N₂O=500 ppm
O₂=approx. 20%
H₂O: 7.5 vol.-%
balance: N₂

Temperature range: up to 450° C.

Decomposition of N₂O>99% at T<450° C.

Catalyst<2% Pd on aluminium oxide

Type: pellets, beads, strands

Diameter<10 mm

The gas composition was fed across the catalyst at 420 to 450° C. at a space velocity of 4,000 h⁻¹. This resulted in complete decomposition of the N₂O. ¹In chemical reactor design, space velocity represents the relation between volumetric flow and reactor volume (or catalyst bed volume).

1. (canceled)

2. (canceled)

3. (canceled)

4. (canceled)

5. (canceled)

6. A method for decomposing nitrous oxide comprising feeding a nitrous oxide-containing gas across a Pd/Al₂O₃ catalyst at a temperature of up to 450° C., wherein the nitrous oxide-containing gas has a moisture content of between about 5-20% H₂O.

7. The method according to claim 6 wherein the nitrous oxide-containing gas is fed across the catalyst at temperature of up to 420° C.

8. The method according to claim 7 wherein the nitrous oxide-containing gas is fed across the catalyst at a temperature of up to 400° C.

9. The method according to claim 6 wherein the gas is an oxygen-containing gas.

10. The method according to claim 9 wherein the gas is air.

11. The method according to claim 6 wherein the Pd content of the catalyst is <2 wt. % with respect to Al₂O₃.

12. The method according to claim 6 wherein the moisture content of the nitrous oxide-containing gas is between about 5-10%.

13. The method according to claim 6 wherein the space velocity of the feed is >4000 h⁻¹.

14. The method according to claim 6 wherein up to 99% of the nitrous oxide is decomposed.
